(19) United States
(12) Patent Application Publication
(10) Pub. No.: US 2005/0228775 A1
(43) Pub. Date: Oct. 13, 2005

(54) Method and apparatus for adaptive personalization of navigation

(75) Inventors: Lars Nilsen, Santa Cruz, CA (US); Donna Boyer, San Francisco, CA (US); Nilesh Gohel, Fremont, CA (US); Nitin Sharma, Mountain View, CA (US); Pete Orelup, Captain Cook, HI (US); Ken Thomas, Santa Clara, CA (US); Scott Gatz, San Francisco, CA (US); Jawahar Malhotra, Los Altos, CA (US); Harry S. Fung, Milpitas, CA (US)

Correspondence Address: DARBY & DARBY P.C., P.O. BOX 5257, NEW YORK, NY, 10150-6257, US

(73) Assignee: Yahoo! Inc., Sunnyvale, CA (US)

(21) Appl. No.: 11/000,431

(22) Filed: Nov. 30, 2004

Related U.S. Application Data
(60) Provisional application No. 60/559,101, filed on Apr. 2, 2004.

(51) Int. Cl. G06F 17/30

(52) U.S. Cl. 707/2

(57) ABSTRACT

A system for dynamically adaptively personalizing at least one navigation control for a web site. Based on collected behaviors for a user, at least one navigation control is dynamically updated to link to a portion of the web site that may be of most interest to the user. Personalized navigation controls for accessing portions of the web site can be dynamically arranged on the web page displayed to the user. Additionally, the personalized navigation may be employed to drives screens of a mobile or living room device.

### CROSS REFERENCE TO RELATED APPLICATIONS

This application claims the benefit of U.S. Provisional Application No. 60/559,101 filed on Apr. 2, 2004, the benefit of the earlier filing date of which is hereby claimed under 35 U.S.C. § 119 (e) and further incorporated by reference.

### FIELD OF THE INVENTION

The invention is related to web sites, and in particular to a method and apparatus for providing personalized web site navigation.

### BACKGROUND OF THE INVENTION

In the past, there have been attempts to customize navigation controls for a users online shopping experience. This customization has been largely based on certain shopping related behaviors and provided information, e.g., prior purchases, product browsing, contents of a virtual shopping cart, personal ranking of a particular product and product ownership. Previously, these navigation customizations were relatively static and did not adapt to the natural changes in a users browsing behavior over relatively brief periods of time.

### BRIEF DESCRIPTION OF THE DRAWINGS

Nonlimiting and non-exhaustive embodiments of the present invention are described with reference to the following drawings, in which:

FIG. 1 shows a diagram of an embodiment of a personalized header that includes personalized links;

FIG. 2 illustrates a diagram of another embodiment of a personalized header, which includes alert links;

FIG. 3 shows a flow chart of an embodiment of a process for providing personalized navigation on a web site;

FIG. 4 illustrates a flow chart of an embodiment of a process for collecting and storing usage information;

FIG. 5 shows a flow chart of an embodiment of a process for performing a usage threshold determination;

FIG. 6 shows a chart illustrating an embodiment of personalized links for a number of users on two different days;

FIG. 7 illustrates a flow chart of an embodiment of a process for providing links to a web page;

FIG. 8 illustrates a block diagram of an embodiment of a system for providing personalized navigation for a web site;

FIG. 9 shows a block diagram of an embodiment of the system of FIG. 8;

FIG. 10 shows a block diagram of another embodiment of the system of FIG. 8;

FIG. 11 illustrates a block diagram of yet another embodiment of the system of FIG. 8 in which an embodiment of the personalized linker server (PLS) box of FIG. 10 is shown in greater detail;

FIG. 12 shows a block diagram of an embodiment of classes that may be employed in software for one or more of the PLS servers of FIG. 11;

FIG. 13 illustrates a diagram showing embodiments of inputs and outputs for functions illustrated in FIG. 12;

FIG. 14 shows an embodiment of a storage format that may be employed by the memory of FIG. 11; and

FIG. 15 illustrates still another embodiment of the system of FIG. 8 in which an embodiment of a transaction flow, including secondary data paths, is shown, in accordance with aspects of the invention.

### DETAILED DESCRIPTION

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may.

Briefly stated, the present invention is directed to a method and apparatus for dynamically adaptively personalizing at least one navigation control for navigating a web site. Based on collected behaviors for a user, at least one navigation control is dynamically updated to link to that portion of the web site that may be of most interest to the user. In one embodiment, the user could opt out of personalization of the navigation control based on user behavior by not logging into the web site. In another embodiment, personalized navigation is provided for users that are not logged it. In one embodiment, three personalized navigation controls for accessing portions of the web site are dynamically arranged on a web page displayed to the user. In another embodiment, the personalized navigation may be employed to drives screens of a mobile or living room device.

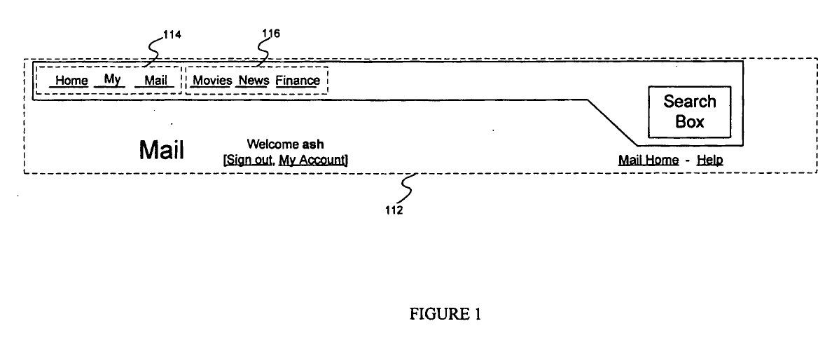

FIG. 1 shows a diagram of an embodiment of personalized header 112. Personalized header 112 includes section 114, which includes static navigation links, and section 116, which may include personalized navigation links.

In one embodiment, personalized header 112 is provided on each web page of a web site for a user whenever the user is logged in to the web site. The web site may include several different portions, herein referred to as properties. Each of the properties may be associated with a particular category. Further, each of the navigation links in sections 114 and 116 may be a link to one of the properties of the web site. In one embodiment, properties may include categories such as address book, calendar, chat, city guides, education, finance, groups, movies, news, photos, sports, weather, and the like. Each property may have its own associated web server.

The navigation links in section 114 may be static in that they do not vary from user to user. If the web site is accessed by someone other than a logged-in user, the links in section 114 may be provided in a non-personalized header on the webpage. The term “logged-in user” refers to a user that is logged in to the web site.

However, if a logged-in user accesses one of the web pages in the web site, personalized header 112, which may include personalized navigation links in section 116, may be provided on the web page. Section 116 may include personalized navigation links to properties that the user has visited relatively frequently. In one embodiment, the personalized links are “most used property” links. In one embodiment, personalized header 112 appears relatively near the bottom of the web page. In other embodiment, personalized header 112 may appear in another location on the web page.

In one embodiment, the personalized links included in section 116 are the three properties that the user has used most frequently. In one embodiment, a personalized link will only appear in section 116 if the usage of the property by the user has reached a threshold that is associated with the property. In one embodiment, “usage” is measured as the number of days over the last thirty days that the user visited the property. A threshold may be determined for each property, and the threshold may be different for different properties. In this embodiment, depending on usage history, some users may have less than three properties displayed in section 116. In one embodiment, if the users usage of less than three of the properties meet the associated threshold, less than three navigation links appear in section 116. In another embodiment, three links are employed in section 116, and if the users usage of less than three of the properties meet the associated threshold, then recommended and/or promotional properties are used for the remaining links in section 116. Promotional links may be determined in a number of ways, and may be based on demographics or other user segmentations.

In one embodiment, the threshold for one or more of the properties may be dependent on the overall usage by the user. For example, in one embodiment, each user is classified as a light, medium, or heavy user based on overall usage by the user. Some or all of the thresholds may vary depending on whether the user is classified as a light, medium, or heavy user.

In one embodiment, only links to properties are included in personalized header 112. In other embodiments, link to sub-properties may also be employed.

Although a personalized header is illustrated in FIG. 1, in other embodiments, personalized links may be provided to a logged-in user in places other than a header, in addition to or instead of providing the personalized links in header 112. In one embodiment, the personalized links appear both in a universal header and to the left or right of the web site masthead on the web site home page if the user is logged in.

In one embodiment, some properties include the masthead, and other properties do not include the masthead. In one embodiment, properties which include the masthead do not include header 112. Properties which include the masthead may include personalized section 116 to the left or right of the masthead, and properties that include header 112 may include personalized section 116 in header 112.

In one embodiment, as previously discussed, personalized header 112 is provided to a user only if the user is logged in. In this embodiment, if the user is not logged in, a non-personalized header may be provided instead.

In another embodiment, the personalized header may be provided to a user that need not be logged in, and need to be a registered user. In this embodiment, one or more cookies may be employed to monitor to the users usage of the properties.

In one embodiment, rather than or in addition to providing the links on a web site, the links may be provided within a menu or submenu of a navigation system for a non PC device such as a mobile device or a living room device that is capable of accessing the internet. The links may be included in a menu or submenu. Usage from overall web activity and/or only device specific behavior may be used as a basis for determining navigation links. In one embodiment, the menu or submenu selections can be made by using a remote control.

In one embodiment, behavior recorded from a specific device or browsing application may be used to determine the navigation links regardless of whether the user is logged in or which set of users are using the device or application. In one embodiment, browser cookies are used to monitor the behavior of the user regardless of whether the user is logged in. Also, the personalized links are available to the user regardless of whether the user is logged in. In one embodiment, the personalized links may be accessed from a web page regardless of whether the user is logged in. In another embodiment, the personalized links may be accessed by making a menu or submenu selection.

Since some embodiments of the invention may track in logged-in users, and other embodiment of the invention may track behavior of the client device, regardless of who is using the device, the term “user” is used broadly throughout the specification and claims. It may be used to refer to, in one embodiment, a registered user whose usage is tracked when logged in. It may also be used to refer to, in another embodiment, the client device, where the usage of the client device is tracked without regard to the particular individual using the client device.

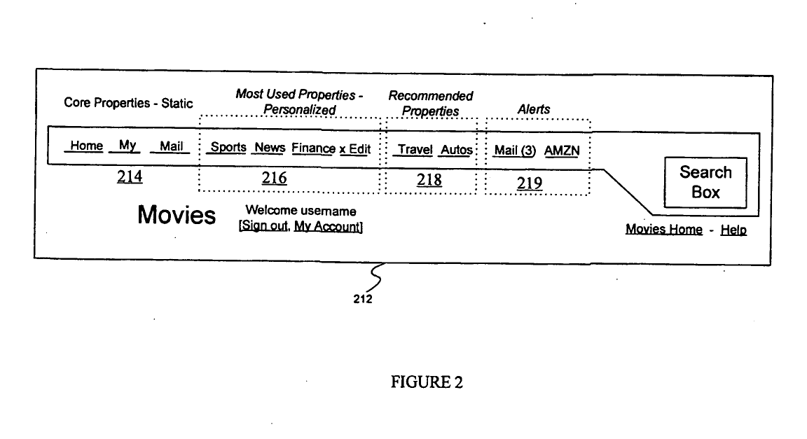

FIG. 2 illustrates a diagram of an embodiment of personalized header 212. Personalized header 212 may be substantially similar to personalized header 112 in some ways, albeit different in other ways. Personalized header 212 further includes recommended properties section 218 and alerts section 219.

Recommended properties section 218 may include navigation links to recommended properties based on previous user activity. Alerts links section 219 may include links associated with alerts such as mail alerts, and non-mail alerts such as stock alerts.

Also, in the embodiment of section 216 illustrated in FIG. 2, an edit link is included. The user may use the edit link to adjust section 216 to:
Allow the system to continue determining which property links are present (adaptive personalization),
Choose which property links are present (active customization)
Remove the presence of the link, and/or
Make the three determinations above for each of the three link slots.

In one embodiment, when choosing which property links are present, the user will be given a menu of properties to choose from, and may not freely choose any URL for a link. In another embodiment, the user may freely choose any URL for a link.

As previously discussed, in one embodiment, personalized navigation may be accomplished with a header in some properties, and with a masthead in other properties. In one embodiment, most used properties section 216 may be placed to the left of the masthead, and recommended properties section 218 may be placed to the right of the masthead.

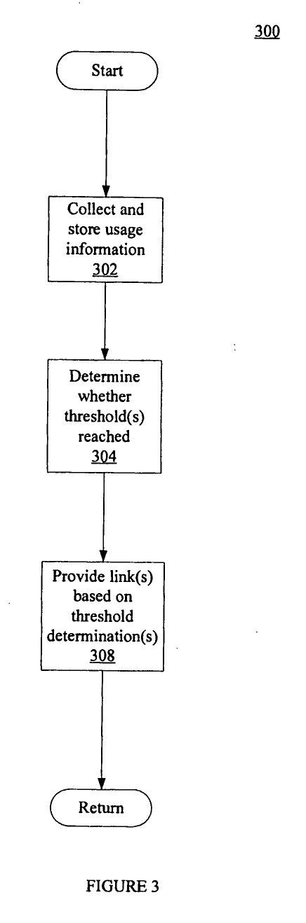

FIG. 3 shows a flow chart of an embodiment of process 300. Process 300 may be employed to provide personalized navigation on a web site. Process 300 may be employed to provide a user with a personalized header if the user is logged in, such as personalized header 112 of FIG. 1 or personalized header 212 of FIG. 2. Process 300 may also be employed to provide links in locations other than a header, as previously discussed.

After a start block, the process proceeds to block 302, where usage information for each user is collected and stored. The usage information may include history of accesses to web pages of the web site for each user while the user was logged in.

The process then proceeds to block 304, where, for each user, a determination is made for each property as to whether the usage of the property by the user reached a threshold that is associated with the property. In one embodiment, as previously described, “usage” is measured as the number of days over the last thirty days that the user visited the property. In this embodiment, the threshold for each property may be defined as the number of days in the last 30 days that user must have visited the property while logged in order for the threshold to be met. In one embodiment, the determination is made every three days covering a thirty day rolling window. However, the invention is not limited to these embodiments, and virtually any usage criteria may be employed.

The process then proceeds to block 308, where links are provided to the client device. The provided links are based, at least in part, on the threshold determinations of block 304. In one embodiment, personalized links are only provided to logged-in users. The process then proceeds to a return block, where other processing is performed.

In one embodiment, process 300 may be employed to allow a user to navigate the web site, where the user is using a desktop computer, laptop computer, or the like. In another embodiment, as previously discussed, process 300 may be employed to drive navigation for a mobile phone, a living room device, and the like. The personalized links may be useful for a device in which screen real estate is limited or the user interface is cumbersome.

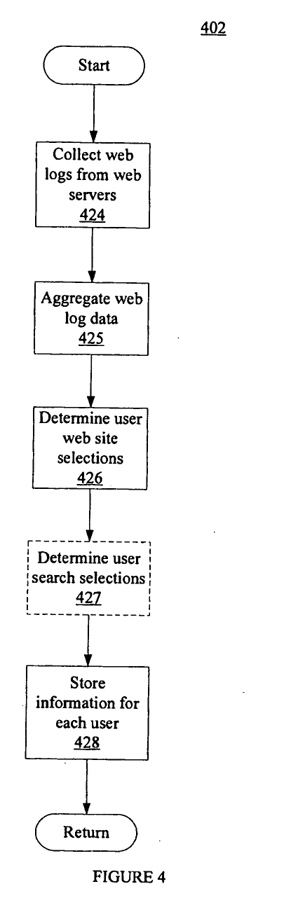

FIG. 4 illustrates a flow chart of an embodiment of process 400 for collecting and storing usage information. An embodiment of process 402 may be employed as an embodiment of block 302 of FIG. 3.

After a start block, the process proceeds to block 424, where web logs of each of the property web servers are collected. In one embodiment, the web server for each of the properties of the web server keeps a web log for each user that is logged into the web site and visits the property. In other embodiments, the web server may keep web log data for clients that are not logged-in users.

The process then advances to block 425, where collected web log data is combined into an aggregated web log. The process then proceeds to block 426, where web site selections of each user are determined. More specifically, in one embodiment, the number of days that the user has visited each property over the last 30 days is determined.

In one embodiment, the process then proceeds to optional block 427. In optional block 427, the users search selections on search engines are determined. The process then proceeds to block 428, where the determined user web site selections, and the determined user search selections (if determined), are stored in a database.

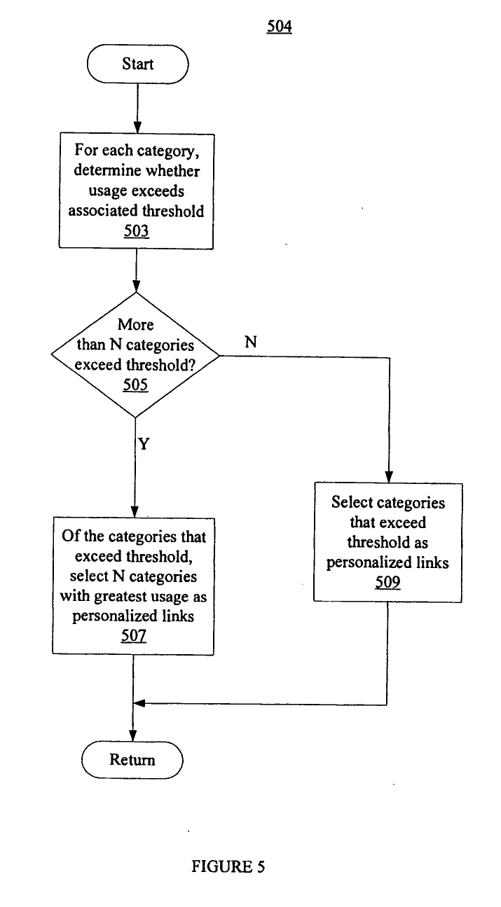

FIG. 5 shows a flow chart of an embodiment of process 504 for performing a usage threshold determination. An embodiment of process 504 may be employed as an embodiment of block 304 of FIG. 3.

After a start block, the process proceeds to block 503, where for each user, and for each property, it is determined whether usage by the user reaches the threshold for the property. The process then proceeds to decision block 505, where it is determined whether more than N categories exceed their respective threshold. In one embodiment, N is three. In other embodiments, N may be a number other than three.

If more than N categories exceed the threshold, the process proceeds to block 507. At block 507, of the properties that reach their respective threshold, the N properties with the most usage are selected as personalized links. In one embodiment, “most usage” means most absolute usage, so that the N properties with the greatest absolute usage are selected as the personalized links. In another embodiment, “most usage” means most relative usage, so that the N properties with the greatest usage relative to their respective threshold are selected as the personalized links. In either case, an algorithm may be employed to determine which properties to select as the personalized links. The process then proceeds from block 507 to a return block, where other processing is resumed.

If the determination at decision block 505 is negative, the process proceeds from decision block 505 to block 509, where the properties that exceeded the threshold are selected as the personalized links. The process then proceeds from block 509 to the return block.

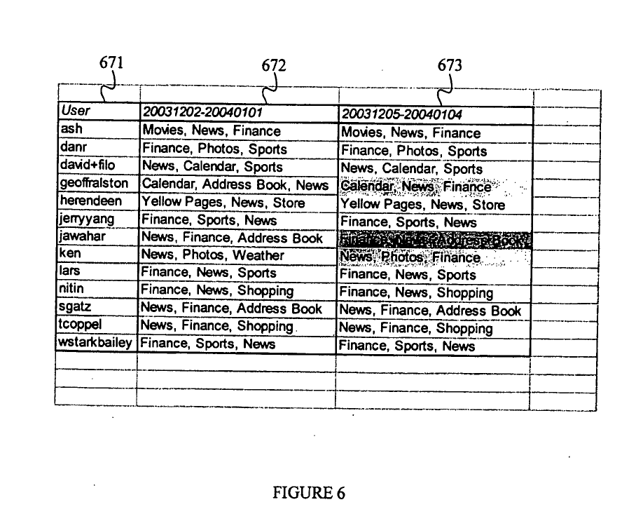

FIG. 6 shows a chart illustrating an embodiment of personalized links for a number of users on two different days. In column 671 of the chart, several user names are listed. In column 672 of the chart, the personalized links (determined e.g. by process 504 of FIG. 5) determined in a first day for each of the users of column 671 are shown. In column 673 of the chart, the personalized links determined on a subsequent day for each of the users is shown. As shown in FIG. 6, the personalized links for users geoffralston and ken have changed, and the order for the personalized links for user jawahar has changed. Accordingly, the personalized links that will be display to users geoffralston and ken will be updated. In one embodiment, if only the order has changed, as is the case for user jawahar, the order of the personalized links is not changed when displayed on the web page.

In one embodiment, changes in personalized links are emphasized, for example, by bolding the new personalized links or by displaying the new personalized links in a different color.

Also, in one embodiment, static links are displayed in the header if the user is not logged in, and personalized links (or possibly recommended and/or promotional links, if the threshold has not be met for all personalized link slots) are displayed in place of the static links when the user is signed in. In one embodiment, the order of the links used when the user is logged in is selected to minimize difference between the links that appear when the user is signed and the links that appear when the user is signed out. For example, in this embodiment, if the signed-out defaults are news, sports, and finance, then personalized links of user danr would be rearranged from finance, photos, and sports to photos, sports, and finance, so that only the first link “news” changes when danr logs in to the web site.

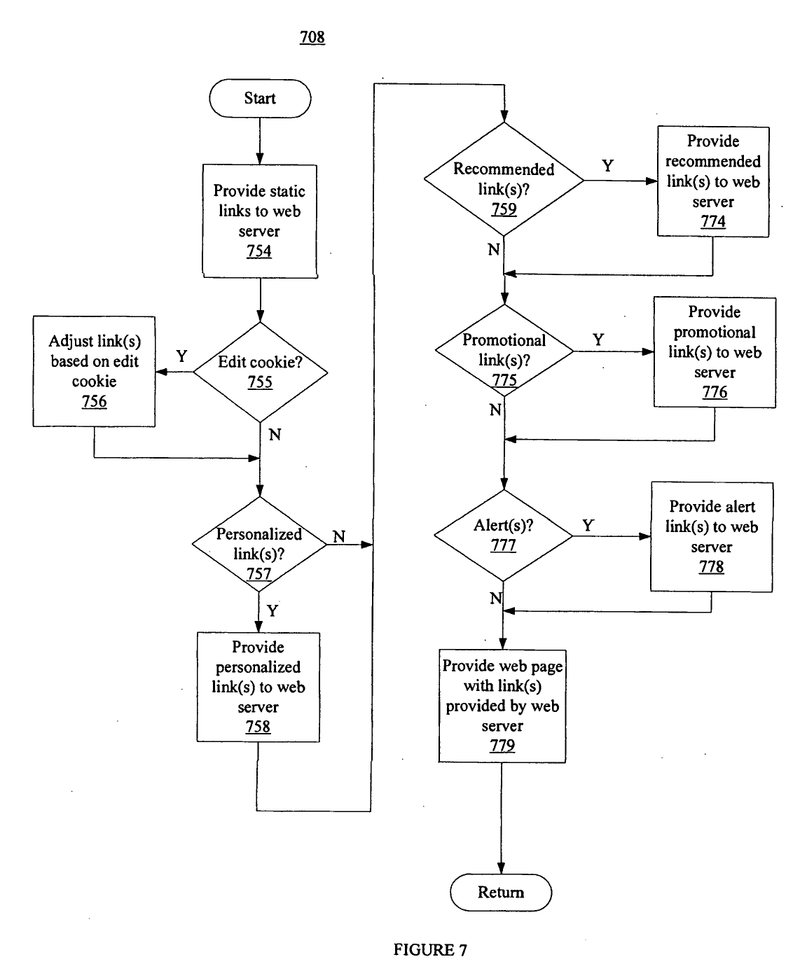

FIG. 7 illustrates a flow chart of an embodiment of process 708, which may be employed for providing links to a web page to a user. Process 708 may be used as an embodiment of block 308 of FIG. 3.

After a start block, the process moves to block 754, where static links are provided to a web server. Next, the process proceeds to decision block 755, where it is determined whether an edit/cache cookie has been set that would change the links displayed on the page for the user.

If the determination at decision block 755 is negative, the process then advances to decision block 757, where a determination is made as to whether there are personalized links for the user. If so, the process proceeds to block 758, where the personalized links are provided to the web server.

The process then proceeds to decision block 759, where a determination is made as to whether there are recommended links for the user. If not, the process moves to decision block 775, where a determination is made as to whether there are promotional links for the user. If not, the process proceeds to decision block 777, where a determination is made as to whether there are alert links for the user. If not, the process proceeds to block 779, where a web page is provided to the user with the links provided to the web server. The process then proceeds to a return block, where other processing is resumed.

If the determination at decision block 755 is positive, the process moves from decision block 755 to block 756, where the links are adjusted based on the edit/cache cookie. The process then advances to block 757.

If the determination at decision block 757 is negative, the process proceeds from decision block 757 to decision block 759. If the determination at decision block 759 is positive, the process moves to block 774, where the recommended links are provided to the web server. In one embodiment, the recommended links are previously determined during data processing, and the previously determined recommended links are provided. In another embodiment, the recommended links are determined during real time at block 774.

The process then advances to decision block 775. If the determination at decision block 775 is positive, the process proceeds to block 776, where the promotional links are provided to the web server. The process then advances to decision block 777. If the determination at decision block 777 is positive, the process moves to block 778, where the alert links are provided to the web server. The process then proceeds to block 779.

At blocks 755, 758, 774, 776, and 778, in one embodiment, the links may be provided to the web server by sending the links to an ad server, which in turns sends the links to the web server. In another embodiment, the links are provided directly to the web server.

In the embodiment discussed, links are provided to a web server. In another embodiment, the links are provided to the client device and not to a web server. For example, in one embodiment, the links are provided to a mobile device or a living room device so that the user may access the links (e.g. from a submenu, or the like) at any time.

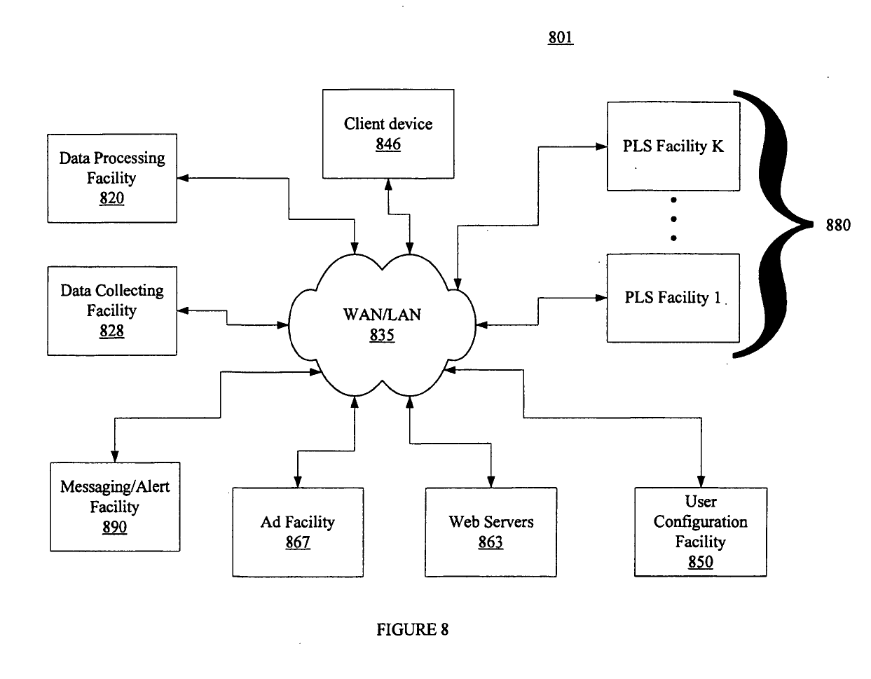

FIG. 8 illustrates a block diagram of an embodiment of system 801, which may be employed for providing personalized navigation for a web site. System 801 may include WAN/LAN 835, data collecting facility 828, data processing facility 820, one or more PLS facilities 1-K 880, ad facility 867, web servers 863, user configuration facility 850, client device 846, and messaging/alert facility 890. System 801 may include many more components that illustrated in FIG. 8, and may also include fewer components than illustrated in FIG. 8. For example, if alert links are not being implemented, messaging/alert facility 890 need not be included in system 801.

WAN/LAN 835 is enabled to employ any form of computer readable media for communicating information from one electronic device to another. Also, WAN/LAN 835 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, to enable messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art.

WAN/LAN 835 may further employ a plurality of wireless access technologies including, but not limited to, 2nd (2G), 3rd (3G) generation radio access for cellular systems, Wireless-LAN, Wireless Router (WR) mesh, and the like. Access technologies such as 2G, 3G, and future access networks may enable wide area coverage for mobile devices with various degrees of mobility. For example, WAN/LAN 835 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like.

Furthermore, remote computers and other related electronic devices could be remotely connected to either LANs or WANs via a modem and temporary telephone link. In essence, WAN/LAN 835 may include any communication method by which information may travel between network devices.

The media used to transmit information in communication links as described above illustrates one type of computer-readable media, namely wired and/or wireless communication media. Generally, computer-readable media includes any media that can be accessed by a computing device. Computer-readable media may include computer storage media, communication media, or any combination thereof. Additionally, communication media typically embodies computer-readable instructions, data structures, program modules, or other data in a modulated data signal such as a carrier wave or other transport mechanism and includes any information delivery media. The terms “modulated data signal,” and “carrier-wave signal” include a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Client device 846 may be any device capable of sending and receiving a packet over a network, and the like, to and from another device. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, client device 846 may include any device that is capable of connecting using a wired or wireless communication medium such as a PDA, POCKET PC, wearable computer, and any other device that is equipped to communicate over a wired and/or wireless communication medium. Client device 846 may be configured to communicate packets with WAN/LAN 835 using a variety of mechanisms.

In one embodiment, client device 846 is a desktop or laptop computer. In another embodiment, client device 846 may be a mobile phone, living room device, or the like.

Web servers 863 may include electronic devices that are configured to employ WAN/LAN 835 to provide a web page in response to a request for a web page. A “web page” means at least a markup language document that can be accessed at a uniform resource locator (URL), web address, and the like over a network. The markup language can include HTML, XML, DHTML, VHTML, WML, HDML, and the like. A web page, when received in response to web servers 835, can be displayed with different applications, including a browser, editor, viewer, and the like. The application used to display the web page is referred to as a “web client” herein.

Each of the web servers 863 may be associated with a different web site property. A user may communicate with web servers 863 via client device 846 for accessing the web site, and for logging into the web site. Further, data collecting facility 828 is configured to collect information from web servers 863 about web pages access by the user.

Also, data processing facility 820 is configured to receive the information collected by data collecting facility 828, and to process the information. Processing the information may include threshold determinations in a similar manner as described above. Data processing facility 828 may employ WAN/LAN 835 to communicate information related to the threshold determinations to personalized link server (PLS) facilities 880.

In one embodiment, Messaging/Alert facility 890 is arranged to employ WAN/LAN 835 to provide mail alert updates and non-mail alert updates to PLS facilities 880.

PLS facilities 880 are each configured to store personalized links for each user. The stored personalized links are based, in part, on information received from data processing facility 820. In one embodiment, PLS facilities 880 also store recommended links, promotional links, and alerts links, where the alert links are based on information received from messaging/alert facility 890. In one embodiment, PLS facilities 880 are also configured to provide stored links to ad facility 867 when requested by ad facility 867. In one embodiment, PLS facilities 880 are configured to provide stored links to web servers 863 when requested by web servers 863.

In one embodiment, data processing facility 820 determines the most used property links, promotional links, recommended links and/or alert links. In another embodiment, one or more of the most used property links, promotional links, recommended links, and/or alerts links are determined in real time and programmed by PLS facilities 880. In one embodiment, promotional and/or recommended links may be determined by PLS facilities based on information in cookies, including demographics and other user segmentations.

Additionally, ad systems facility 867 is configured to employ web servers 863 to provide advertisements on web pages in the web site. However, in one embodiment, ad system facility 867 may also be configured to employ web servers 863 to provide links stored in PLS facilities 880 on web pages in the web site for a user. This way, ad infrastructure which may already be used for providing advertisements on every web page in the web site, may also be used to provide the personalized links to users. In other embodiments, links may be provided directly to PLS facilities 880 rather than providing the links via ad system facility 867. In one embodiment, some property web servers request and receive links from the ad server, and other property web servers request and receive links directly from PLS facilities 880.

User configuration facility 850 may be configured to adjust the links stored in PLS facilities 880, based on, for example, user configurations and preferences. In one embodiment, user configuration facility 850 may be further configured to store user configuration and preferences for backup purposes, and the like.

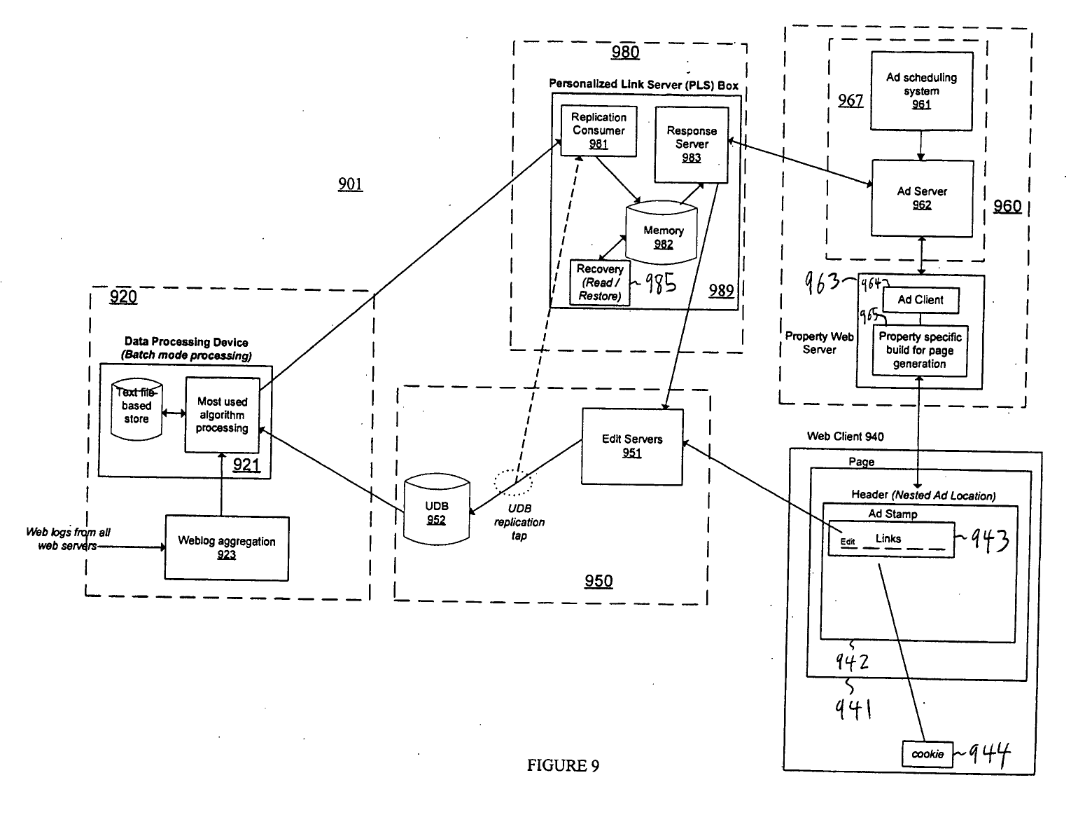

FIG. 9 shows a block diagram of an embodiment of the system 901. System 901 may be employed as an embodiment of system 801 above. Components in system 901 may operate in a similar manner to similarly-named components in system 801, and may operate in a different manner in some ways.

System 901 includes data processing facility 920, PLS facility 980, user configuration facility 950, web client 940, and ad systems/property web server 960. User configuration facility 950 includes universal user data base (UDB) 952 and edit servers 951. PLS facility 980 includes a PLS box, which includes replication consumer 981, memory 982, response server 983, and recovery block 985. Data processing facility 920 includes weblog aggregation block 923 and data processing device 921. Data processing device 921 includes a most used algorithm block and a text file-based store block. Additionally, ad systems/property web server 960 includes ad facility 967 and property web server 963. Property web server 963 includes ad client 964 and page generation block 965. Ad system facility 967 includes ad scheduling system 961 and ad server 962.

In operation, weblog aggregation block 923 receives web logs from each of the property web servers, and provides an aggregated web log based on the received web logs. The web logs may be provided from a data collection facility, such as data collection facility 828 of FIG. 8. In one embodiment, weblog aggregation block 923 provides a feed of 30 day rolling aggregate data.

Data processing device 921 is configured to receive the aggregated web logs from weblog aggregation block 923, and to process the data at periodic intervals. In one embodiment, data processing device 921 processes the data by employing process 504 of FIG. 5. In one embodiment, data processing device 921 determines only personalized links for each user. In another embodiment, data processing device 921 may determine other links for each user, such as recommended links. In either case, data processing device 921 may be configured to provide the determined links to replication consumer 981. In one embodiment, the determined links are only provided to replication consumer 981 if the determined links have changed. In this embodiment, if the determined links have not changed, or if only the order of the links has changed, the links are not provided to replication consumer 981.

In one embodiment, data processing device 921 is configured to run in batch mode and processes data every three days. In other embodiments, other timing may be employed.

Replication consumer 981 is configured to receive the determined links from data processing device 920, and further configured to provide the determined links to memory 982.

Web client 940 is configured to provide web pages from a web site to a user. Web client 940 communicates with the property web server 963 that is associated with web page 941 retrieved to provide web page 941. Each web page may have a property specific build provided by block 965 of property web server 965. Further, web page 941 may include header 942, and header 942 includes ad stamp 943. The information in ad stamp 943, which may include personalized header information, is provided by block 965 of property web server 965.

Block 965 is configured to receive the ad stamp information through communication with ad client 964. Further, ad client 964 is configured to receive the ad stamp information through communication with ad server 962. Ad server 962 may request link information from response server 983, and receive the requested link information in response to the request. In one embodiment, the link information is received in the form of ad identification codes. In this embodiment, ad facility 967 employs ad identification codes, and each property in the web site has a unique ad identification code. The ad identification codes are scheduled by ad scheduling system 961.

For example, in one embodiment, user ash is logged into the web site, and has Movies, News, and Finance as most used properties. Ad server 962 makes a request to response server 983 for the most used properties for user ash, and receives the ad identification codes for Movies, News, and Finance in response to the request. Ad server 962 then resolves the HTML providing links with the received ad identification codes. Accordingly, web client 940, in communication with ad systems/property web server 960, provides the personalized links for Movies, News, and Finance in header 942 for user ash.

Further, response server 983 is configured to respond to requests for link information, including personalized link information, from ad server 962. Response server 983 is arranged to retrieve information from memory 982 for processing the request.

In one embodiment, ad server 962 calls response server 983 for personalized information on every page view for a logged-in user. In one embodiment, response server 983 provides the response to the request from ad server 962 within 10 milliseconds. In one embodiment, the response to the request includes HTML and JavaScript code. In one embodiment, in addition to providing the ad identification code, response server 983 also provides JavaScript code for providing edit/cache cookie 944 in web client 940. In one embodiment, response server 983 is configured to allow asynchronous invocation by the ad server. In one embodiment, response server 983 employs GenServer as a platform technology.

In one embodiment, a user may employ an edit link to edit personalized links, as discussed above. In this embodiment, edit servers 951 are arranged to respond to requests for editing the personalized links. Edits servers 951 are arranged to provide the updated personalized link information to UDB 952 and to replication consumer 981, which in turn provides the updated information to memory 982.

If a user manually edits personalized links, some latency may occur until memory 982 is updated with the new information. In one embodiment, when a user manually edits personalized links, in addition to providing the edit information to edit servers 951, cookie 944 is employed so that the changes occur virtually immediately for the user. The information in cookie 944 overrides the link information received from response server 983. Cookie 944 may also be used as a cache to avoid being called repeatedly on subsequent page view. Cookie 944 has a time-to-live so that cookie 944 expires after a certain period of time, at which point memory 982 should be updated with the new information.

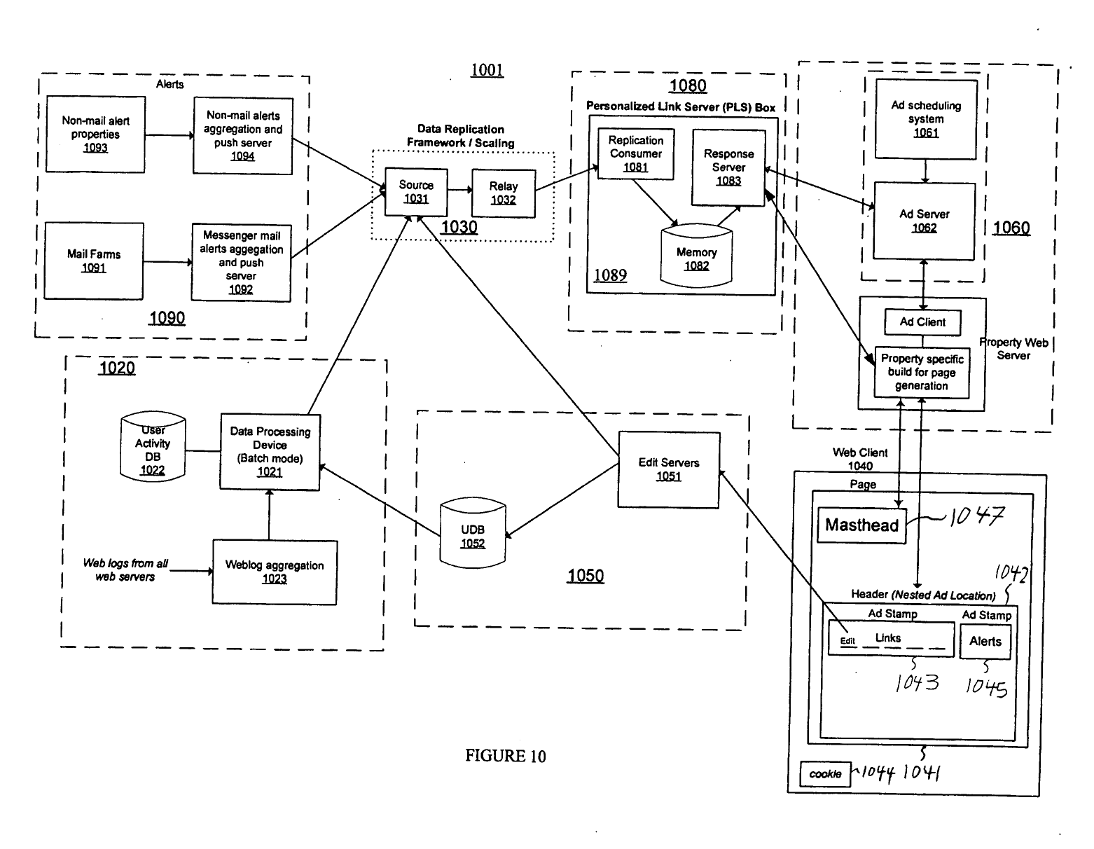

FIG. 10 shows a block diagram of an embodiment of system 1001. System 1001 may be employed as an embodiment of system 801 and/or system 1001 above. Components in system 1001 may operate in a similar manner to similarly-named components in system 801 and/or system 901, and may operate in a different manner in some ways.

System 1001 further includes data replication block 1030, which may be included in network 835 of FIG. 8. Alert facility 1090 includes mail farms block 1091, messenger mail alerts aggregation and push server 1092, non-mail alert properties block 1093, and non-mail alerts aggregation and push server 1094.

In operation, mail farms block 1091 provides mail alerts to server 1092. Server 1092 is configured to aggregate the mail alerts and provide them to source 1031. Also, non-mail alerts property 1093 are arranged to provide non-mail alerts to server 1094. Non-mail alerts may be related to sports, weather, stock, or any other type of non-mail alert. Server 1094 is configured to aggregate the non-mail alerts and provide them to source 1031.

Source 1031 is arranged to receive link information from data processing device 1021, server 1092, server 1094, and edit servers 1051; and to provide the information to relay 1032. Further, relay 1032 is configured to provide the information to each of the PLS facilities. In one embodiment, relay 1032 is configured to provide the information to two PLS facilities, where one PLS facility is on the west coast of the United States of America, and the other PLS facility is on the east coast of the United States of America.

Web page 1041 may include header 1042 for some or all or the properties, and may include masthead 1047 for some or all of the properties. In one embodiment, web page 1041 includes masthead 1047 and not header 1042 for some of the properties, and includes header 1042 and not masthead 1047 for each of the other properties.

In one embodiment, for properties in which masthead 1047 is provided, property web server 963 requests link information for a user directly from response server 1083. Response server 1083 provides the link information to response server 1083 in response to the request. Property web server 1063 provides the information to web client 1040 so that the links may be displayed in masthead 1047.

As previously discussed, in one embodiment, a web server need not be employed for providing links to client 940. For example, client 940 may request personalized links from response server 983 to display the links in a menu, submenu, or the like, as previously discussed.

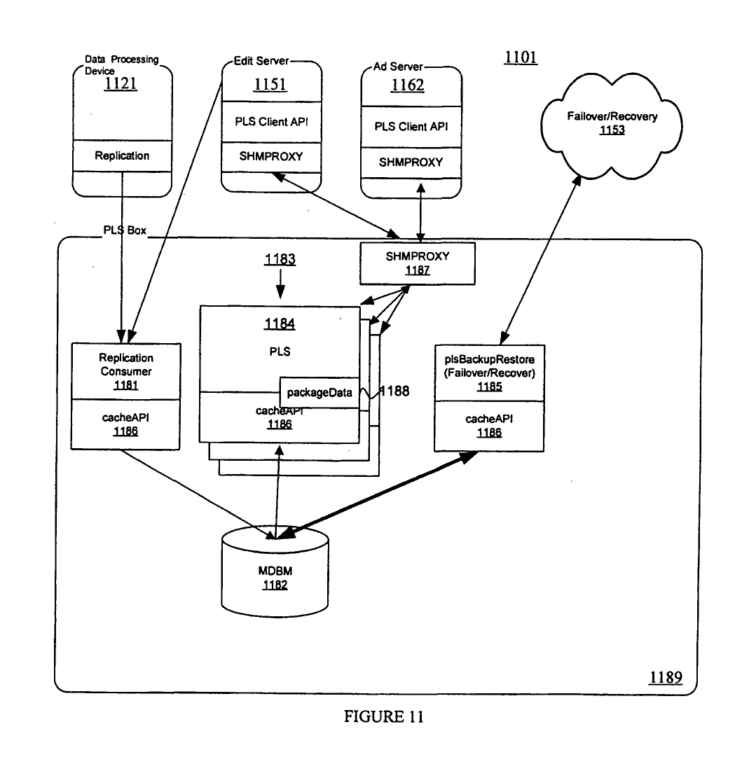

FIG. 11 illustrates a block diagram of an embodiment of system 1101, in which an embodiment of a PLS box is shown in greater detail. Components in system 1101 may operate in a substantially similar manner to similarly-named components in system 801 of FIG. 8, system 901 of FIG. 9, and system 1001 of FIG. 10, and may operate in a different manner in some ways.

Response server 1183 may include several PLS servers 1184. Multiple PLS servers may be employed for load-balancing and fail-over. Users may be partitioned among the PLS servers. In one embodiment, the partitioning among PLS servers 1184 is based on username.

Memory 1182 may be implemented as a memory data base manager (MDBM).

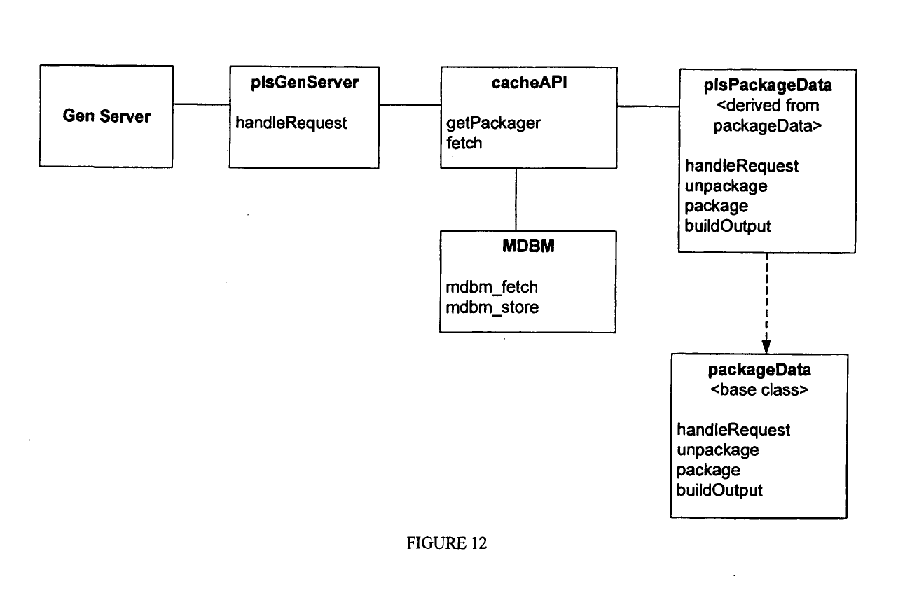

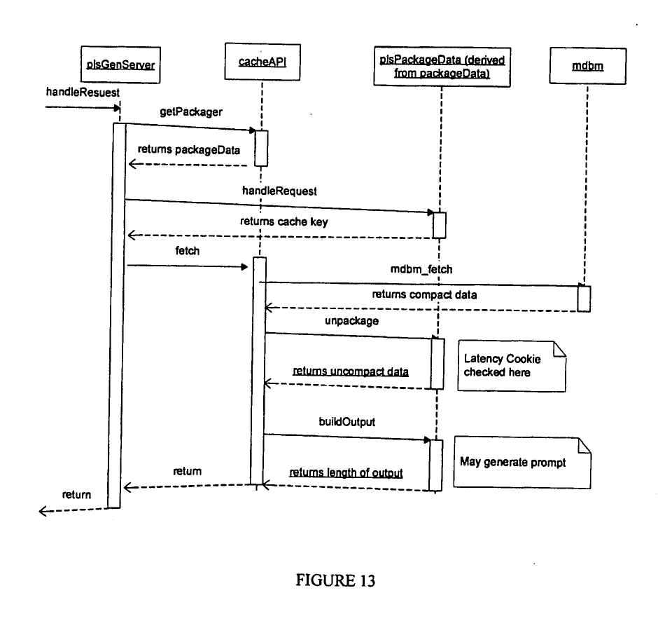

FIG. 12 shows a block diagram of an embodiment of classes that may be employed in software for a PLS servers such as PLS server 1184 of FIG. 11. FIG. 13 illustrates a diagram showing embodiments of inputs and outputs for functions illustrated in FIG. 12.

Library plsGenServer may be employed to handle the response server tasks, including getting data following a genServer header, and building the genServer response header. Also, library plsGenServer uses cacheAPI to handle all interaction with the cache (i.e. memory 1182).

Library cacheAPI is employed to encapsulate the MDBM calls. Also, the cacheAPI acts as a single point for all MDBM configuration. The cacheAPI is used by PLS servers 1184, replication consumer 1181, and recovery utilities 1185. In one embodiment, the cacheAPI employs an abstract class, packageData, for all data formatting.

Further, class plsPackageData is derived from class packageData for PLS specific data. In one embodiment, plsPackageData is used for incoming messages from the genServer client, the format of data stored in the cache and/or cookies, and the format of responses to send back to the genServer client.

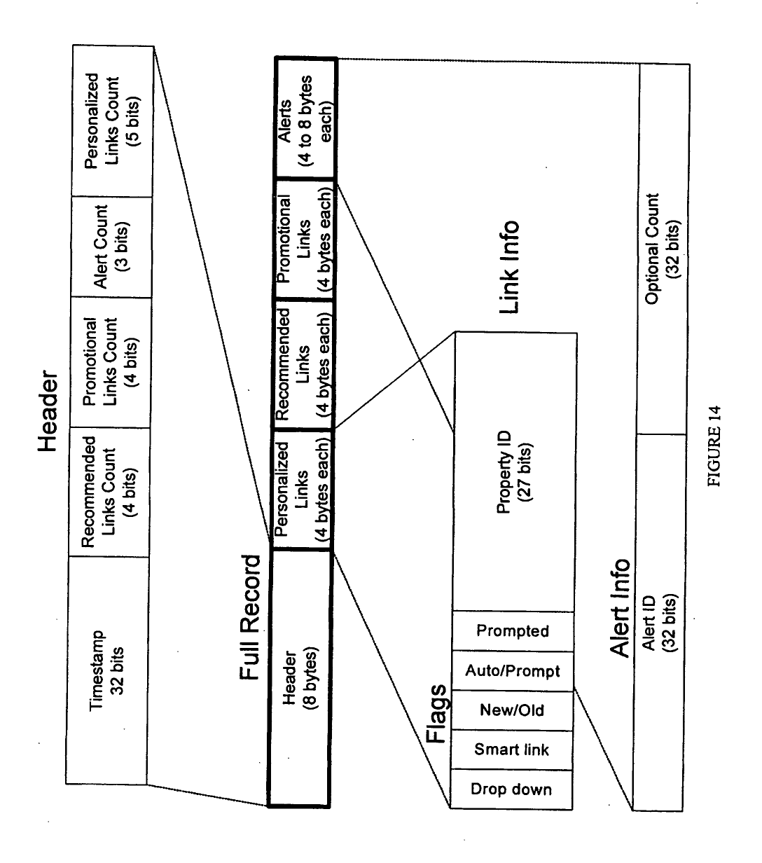

FIG. 14 shows an embodiment of a data storage format employed by memory 1152 of FIG. 11. Many other embodiments of a data storage format than the embodiment illustrated in FIG. 14 may be employed, which serves only as an illustrative example.

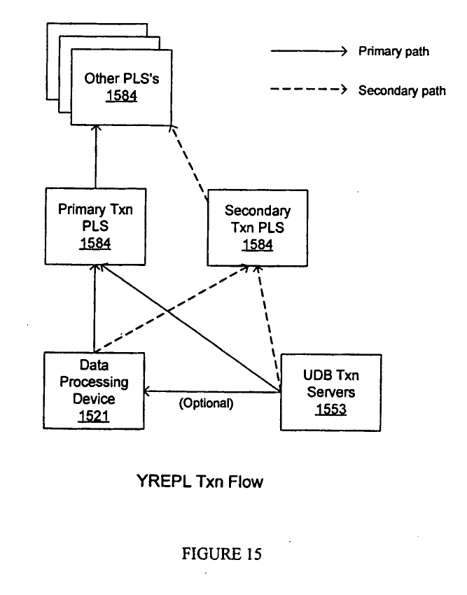

FIG. 15 an embodiment of part of system 1501. Components in system 1501 may operate in a substantially similar manner to similarly-named components described above, and may operate in a different manner in some ways. In FIG. 15, replication transaction flow is indicated, along with secondary paths that may be employed for fail over purposes, and the like. System 1501 includes data processing device 1521, UDB transactions servers 1553, primary transaction PLS 1584, secondary transaction PLS 1584, and other PLSs 1584.

The above specification, examples and data provide a description of the manufacture and use of the composition of the invention. Since many embodiments of the invention can be made without departing from the spirit and scope of the invention, the invention also resides in the claims hereinafter appended.

1. A method for providing at least one navigation link, comprising:
collecting usage information for a user, wherein the usage information is associated with usage, by the user, of at least one of a plurality of portions of a web site;
based on the usage information, for each of the plurality of portions, determining whether the usage of the portion reaches a threshold that is associated with portion;
determining personalized navigation data for the user based, in part, on the threshold determinations;
storing the personalized navigation data; and
at least if the user is logged in to the web site, employing an ad server to provide the at least one navigation link to the user such that the at least one navigation links includes at least one navigation link that is based on the stored personalized navigation data.

2. The method of claim 1, further comprising:
employing the usage information to determine an overall usage by the user; and
determining the threshold associated with each of the plurality of portions for the user, such that each of the determined thresholds is determined based, in part, on the overall usage by the user.

3. The method of claim 1, wherein determining whether the usage of the portion reaches the associated threshold includes:
employing the usage information to determine, for each of the plurality of portions, how many days during a time interval the user accessed the property while the used is logged in to the web site; and
determining whether the number of days during the time interval the user accessed the property while logged in reaches the associated threshold.

4. The method of claim 3, wherein the time interval includes the 30 previous days.

5. The method of claim 1, further comprising:
enabling the user to make a request for editing at least a portion of the at least one navigation link; and
if the request for editing is made, changing the stored personalized navigation data based on the request for editing.

6. The method of claim 5, further comprising:
if the request for editing is made, employing a cookie to change the at least one navigation link based on the request for editing.

7. The method of claim 1, wherein the personalized navigation data includes information identifying at least one personalized link if usage of at least one of the plurality of portions reaches the associated threshold.

8. The method of claim 7, wherein the personalized navigation data further includes information identifying at least one recommended link that is associated with a portion of the plurality of portions.

9. The method of claim 7, further comprising:
determining alert information for the user, wherein the personalized navigation data further includes information identifying at least one alert link that is associated with the determined alert information, wherein the alert link is associated with a portion of the plurality of portions.

10. The method of claim 7, wherein determining the personalized navigation data includes:
if the usage of less than N+1 of the portions exceeded the associated threshold, providing data identifying each of the portions for which the usage reaches the associated threshold as the information identifying the at least one personalized link, wherein N is a predetermined integer; else:
determining, based on an algorithm, which N portions among the portions that exceed the threshold are used most frequently by the user; and
providing the determined N portions as the information identifying at least one personalized link.

11. The method of claim 10, wherein N is three.

12. The method of claim 10, wherein collecting the usage information includes:
at least if the user is logged in to the web site:
for each web server of a plurality of web servers that provides web pages for the web site, if the user accesses a web page provided by the web server, employing the web server to store information about the access in a web log; and
collecting the web logs from each of the plurality of web servers that provides web pages for the web site.

13. A network device for data processing for personalized navigation of a web site, comprising:
a transceiver that is arranged to send packets; and
a processor that is configured to perform actions, including:
receiving aggregated data from a plurality of web servers, including usage information that is associated with usage, by a user, of at least one of a plurality of portions of a web site;
based on the usage information, for each of the plurality of portions, determining whether the usage of the portion reaches an associated threshold;
determining personalized navigation data for the user based, in part, on the threshold determinations; and
enabling the transceiver to provide personalized navigation data for the user to a server, to enable at least one navigation link based a portion of the plurality of portions that reaches the threshold determined to be provided to the user if at least one of the plurality of portions reaches the associated threshold.

14. The network device of claim 13, wherein the personalized navigation data includes information identifying at least one personalized link if usage of at least one of the plurality of portions reaches the associated threshold, and wherein the processor is configured to determine the personalized navigation data by:
if the usage of less than N+1 of the portions exceed the associated threshold, providing data identifying each of the portions for which the usage reaches the associated threshold as the information identifying at least one personalized link, wherein N is a predetermined integer;
else:
determining, based on an algorithm, which N portions among the portions that exceed the threshold were used the most frequently by the user;
providing the determined N portions as the information identifying at least one personalized link.

15. The network device of claim 13, wherein the processor is configured to determine whether the usage of the portion reaches the associated threshold by:
employing the usage information to determine, for each of the plurality of portions, how many days during a time interval the user accessed the property while logged in; and
determining whether the number of days during the time interval the user accessed the property while logged in reaches the threshold.

16. The network device of claim 13, wherein the processor is further configured to:
employ the usage information to determine an overall usage by the user; and
determine the threshold associated with each of the plurality of portions for the user, wherein each of the determined thresholds is dependent on the overall usage by the user.

17. The network device of claim 16, wherein the overall usage is the number of days, during a time interval, that the user accessed the web site, and wherein each of the determined thresholds is the number of days that the user must use the property during the time interval in order for the threshold to be met for the property.

18. A personalized link server, including:
a transceiver; and
a processor that is arranged to perform actions, including:
receiving a request for personalized navigation links for a user;
retrieving stored personalized navigation links from a database, wherein the stored personalized navigation links are based, in part, on navigation links that are associated with a portion of a web site for which usage of the portion by the user reaches an associated threshold; and
enabling the transceiver to provide the retrieved personalized navigation links to a server to enable the retrieved personalized navigation links to be provided to the user.

19. The personalized link server of claim 18, wherein the retrieved personalized navigation links are ad identification codes that identify links to portions of the web site.

20. The personalized link server of claim 18, further comprising enabling the transceiver to send code for a cookie in response to the request such that the cookie enables personalized links appearing to the user to be modifiable based on editing performed by the user.

21. An ad server for providing personalized navigation of a web site, comprising:
a transceiver; and
a processor that is arranged to perform actions, including:
enabling the transceiver to request personalized navigation links that are associated with a portion of the web site for which usage of the portion reaches an associated threshold;
receiving the requested personalized navigation links; and
enabling the transceiver to provide information related to the received personalized navigation links to an ad client to enable the ad client to provide the received personalized navigation links to a user.

22. The ad server of claim 21, wherein the retrieved personalized navigation links are ad identification codes that identify links to portions of the web site, and wherein the processor is further configured to resolve HTML code to provide the link identified by the ad identification code, and to provide the resolved HTML code as part of the information related to the received personalized navigation links.

23. A client device for providing at least one navigation link for a web site, comprising:
a transceiver; and
a processor that is arranged to perform actions, including:
at least if a user is logged onto the web site:
determining if an edit cookie indicates that the user has edited the at least one navigation link;
if the edit cookie indicates that the user has edited the at least one navigation link, providing the at least one navigation link based, at least in part, on the edit cookie; and
if the edit cookie does not indicate that the user has edited the at least one navigation link:
requesting personalized navigation links that are associated with a portion of a web site for which usage, by the user, of the portion reaches an associated threshold;
receiving the requested personalized links; and
providing the received personalized navigation links to the user.

24. A computer program, embodied on a computer-readable medium, for providing navigation on a web site, comprising:
a component that is configured to receive usage information for a user, wherein the usage information is associated with a usage of a plurality of portions of the web site;
a component that is configured to determine, based on the usage information, for each of the plurality of portions, whether the usage, by the user, of the portion reaches an associated usage threshold for the portion; and
a component that is configured to, based on the threshold determinations, enable adaptive personalized navigation to be provided such that providing the adaptive personalized navigation includes:
if the usage of at least one of the plurality of portions reaches the associated threshold for the portion, enabling at least one navigation control to be provided for accessing at least one of the plurality of portions that reaches the associated user threshold.

25. The computer program of claim 24, wherein the component that is configured to determine whether the usage of the portion reaches the associated threshold includes:
a component that is configured to employ the usage information to determine, for each of the plurality of portions, how many days during a time interval the user accessed the property while logged in; and
a component that is configured to determine whether the number of days during the time interval the user accessed the property while logged in reaches the threshold.

26. The computer program of claim 24, wherein the component that is configured to enable adaptive personalized navigation includes:
a component that is configured to determine personalized navigation data for the user based, in part, on the threshold determinations; and
a component that is configured to enable the personalized navigation data to be provided to a personalized link server facility.

27. The computer program of claim 26, wherein the personalized navigation data includes information identifying at least one personalized link if usage of at least one of the plurality of portions reaches the associated threshold, and component that is configured to determine the personalized navigation data includes:
a component that is configured to, if the usage of less than N+1 of the portions exceed the associated threshold, provide data identifying each of the portions for which the usage reaches the associated threshold as the information identifying the at least one personalized link, wherein N is a predetermined integer;
a component that is configured to, if the usage is equal to or greater than N+1 of the portions exceed the associated threshold, determine, based on an algorithm, which N portions among the portions that reaches the threshold are used the most frequently by the user, and to provide the determined N portions as the information identifying at least one personalized link.

28. The computer program of claim 26, wherein the component that is configured to enable adaptive personalized navigation further includes:
a component that is configured to employ the usage information to determine an overall usage by the user; and
a component that is configured to determine the threshold associated with each of the plurality of portions for the user, wherein each of the determined thresholds is dependent on the overall usage by the user.

29. The computer program of claim 28, wherein the overall usage is the number of days, during a time interval, that the user accessed the web site, and wherein each of the determined thresholds is the number of days that the user must use the property in order for the threshold to be met for the property.

30. A data structure, embodied in a computer readable medium, for providing at least one navigation link, comprising:
a time field; and
a field that indicates how many personalized links for a user are stored in the data structure, wherein each of the personalized links corresponds to a portion of a web site for which a usage, by the user, of the region reaches an associated threshold.

31. The data structure of claim 30, wherein each of the personalized links is encoded as an ad identification code.

32. An apparatus for providing navigation on a web site, comprising:
means for receiving collected usage information for a user, wherein the collected usage information is associated with a usage of a plurality of portions of the web site;
means for determining, based on the collected usage information, for each of the plurality of portions, whether the usage, by the user, of the portion reaches an associated usage threshold for the region; and
means for enabling, based on the threshold determinations, adaptive personalized navigation to be provided to the user.

33. A mobile device for personalized navigation, comprising:
a transceiver that is arranged to send packets; and
a processor that is arranged to perform actions, including:
requesting personalized navigation links that are associated with a portion of a web site for which usage, associated with the mobile device, of the portion reaches an associated threshold;
receiving the requested personalized navigation links; and
providing a menu of selections, wherein the selections include at least one navigation link based, in part, on the received personalized navigation links.

34. The mobile device of claim 33, further comprising:
enabling a request for editing the at least one navigation link to be made; and
if a request for editing is made:
employing an edit cookie to indicate an edit corresponding to the request for editing; and
providing the at least one navigation link based, at least in part, on the edit cookie.
